(19) United States
(12) Patent Application Publication
(10) Pub. No.: US 2019/0286123 A1
(43) Pub. Date: Sep. 19, 2019

(54) REMOTE VEHICLE CONTROL DEVICE AND REMOTE VEHICLE CONTROL METHOD

(71) Applicant: DENSO TEN Limited, Kobe-shi (JP)

(72) Inventors: Fumiaki BANDO, Kobe-shi (JP); Minoru MAEHATA, Kobe-shi (JP); Miki HITOTSUYA, Kobe-shi (JP)

(73) Assignee: DENSO TEN Limited, Kobe-shi (JP)

(21) Appl. No.: 16/227,174

(22) Filed: Dec. 20, 2018

(30) Foreign Application Priority Data
Mar. 15, 2018 (JP) 2018-048355

(51) Int. Cl. G05D 1/00; G06T 15/20

(52) U.S. Cl. CPC G05D 1/0044; B60R 1/00; G06T 15/205

(57) ABSTRACT

A remote vehicle control device includes: a display unit; an operation unit configured for operating a vehicle; a signal generating unit configured to generate control signals for the vehicle on the basis of operations on the operation unit; and a communication unit configured to perform communication with the vehicle. In-vehicle perspective images which are based on viewpoint positions which are predetermined positions inside the vehicle and sight line directions which are the directions to the outside of the vehicle as seen from the viewpoint positions and include transparent images as images of the vehicle are generated on the basis of plural images acquired by plural individual on-board cameras mounted on the vehicle, the display unit displays the in-vehicle perspective images, and the communication unit transmits the control signals to the vehicle.

### CROSS-REFERENCE TO RELATED APPLICATIONS

This application is based on and claims priority under 35 USC 119 from Japanese Patent Application No. 2018-48355 filed on Mar. 15, 2018.

### BACKGROUND

### Technical Field

The present disclosure relates to a remote vehicle control device and a remote vehicle control method.

### Related Art

Recently, various technologies relates to remote vehicle control have been proposed. For example, a mobile terminal proposed in Patent Literature 1 is a terminal for moving a vehicle from a first position to a second position. This mobile terminal displays bird's eye view images including an image of the vehicle on the basis of images acquired by a camera installed in the terminal, and receives user's operations for the vehicle. Also, for example, a parking assistance device proposed in Patent Literature 2 makes it possible to park a vehicle using a remote control means such as a joystick. Also, for example, a remote vehicle control system proposed in Patent Literature 3 includes a mobile terminal, which transmits control signals corresponding to touch operations on a touch panel, to a vehicle. This mobile terminal may transmit travel control signals and steering control signals to the vehicle.
[Patent Literature 1] Japanese Patent Application Laid-Open No. 2014-65392
[Patent Literature 2] Japanese Patent Application Laid-Open No. 2010-95027
[Patent Literature 3] Japanese Patent Application Laid-Open No. 2016-74285

### SUMMARY

However, the technologies according to the related art have a problem that convenience and operability in remote vehicle control are not thoroughly satisfactory.

It is therefore an object of the present disclosure to provide a technology capable of improving convenience and operability in remote vehicle control.

According to an aspect of the present disclosure, there is provided a remote vehicle control device including: a display unit; an operation unit configured for operating a vehicle; a signal generating unit configured to generate control signals for the vehicle on the basis of operations on the operation unit; and a communication unit configured to perform communication with the vehicle. In-vehicle perspective images which are based on viewpoint positions which are predetermined positions inside the vehicle and sight line directions which are the directions to the outside of the vehicle as seen from the viewpoint positions and include transparent images as images of the vehicle are generated on the basis of plural images acquired by plural individual on-board cameras mounted on the vehicle, the display unit displays the in-vehicle perspective images, and the communication unit transmits the control signals to the vehicle.

In the remote vehicle control device, the communication unit may receive the in-vehicle perspective images generated in the vehicle, from the vehicle.

In the remote vehicle control device, the control signals may include signals related to control on the viewpoint positions and the sight line directions of the in-vehicle perspective images.

In the remote vehicle control device, when approach of another object to the vehicle is detected, the display unit may display in-vehicle perspective images.

In the remote vehicle control device, the display unit may display in-vehicle perspective images based on a sight line direction which is the direction to the position of the object approaching the vehicle.

In the remote vehicle control device, when an impact on the vehicle is detected, the display unit may display in-vehicle perspective images.

In the remote vehicle control device, in a case where the position of the impact is specified in the vehicle, the display unit may display in-vehicle perspective images based on a sight line direction which is the direction to the position of the impact.

In the remote vehicle control device, when a wall is detected in the vicinity of the vehicle, the display unit may display auxiliary images including transparent images as images of the wall.

In the remote vehicle control device, the transparent images of the vehicle in the in-vehicle perspective images may be wireframe images configured with sets of lines representing sides of a three-dimensional shape representing the vehicle.

In the remote vehicle control device, the transparent images of the vehicle in the in-vehicle perspective images may be semi-transparent images of a three-dimensional shape representing the vehicle.

According to an aspect of the present disclosure, there is provided a remote vehicle control method including: generating in-vehicle perspective images which are based on viewpoint positions which are predetermined positions inside a vehicle and a sight line direction which is the directions of the vehicle as seen from the viewpoint positions and include transparent images as images of the vehicle, on the basis of plural images acquired by plural individual on-board cameras mounted on the vehicle; displaying the in-vehicle perspective images on a remote vehicle control device; receiving operations for the vehicle by the remote vehicle control device; generating control signals for the vehicle based on the operations; and transmitting the control signals from the remote vehicle control device to the vehicle.

According to the configuration of the present disclosure, the user may remotely control the vehicle while checking the condition outside the vehicle as seen from the inside of the vehicle, on in-vehicle perspective images. For example, while checking the appearances and behaviors of people and other objects approaching or being in contact with the vehicle, on in-vehicle perspective images, the user may remotely control the vehicle. Also, for example, by converting images of walls existing around the vehicle, it is possible to improve the visibility of the surrounding area of the vehicle. In other words, it is possible to improve convenience and operability in remotely controlling the vehicle.

### BRIEF DESCRIPTION OF THE DRAWINGS

Exemplary embodiments of the present invention will be described in detail based on the following figures, wherein:

FIG. 1 is a block diagram illustrating the configuration of a remote vehicle control system of an embodiment;

FIG. 2 is a view illustrating positions on a vehicle where on-board cameras are disposed;

FIG. 3 is a view for explaining a method of generating a synthetic image showing the surrounding area of the vehicle;

FIG. 4 is a schematic diagram illustrating a mobile terminal displaying a bird's eye view image according to a first example;

FIG. 5 is a schematic diagram illustrating a bird's eye view image displayed on the mobile terminal according to the first example;

FIG. 6 is a schematic diagram illustrating the mobile terminal displaying an in-vehicle perspective image according to the first example;

FIG. 7 is an explanatory view illustrating a virtual viewpoint related to the in-vehicle perspective image according to the first example;

FIG. 8 is a schematic diagram illustrating the in-vehicle perspective image of the first example;

FIG. 9 is a flow chart illustrating an example of the flow of processing of the mobile terminal related to remote vehicle control according to the first example;

FIG. 10 is a flow chart illustrating another example of the flow of processing of the mobile terminal related to remote vehicle control according to the first example;

FIG. 11 is a schematic diagram illustrating the mobile terminal displaying the bird's eye view image and the in-vehicle perspective image according to the first example;

FIG. 12 is a schematic diagram illustrating an in-vehicle perspective image of a second example;

FIG. 13 is a flow chart illustrating an example of the flow of processing of the mobile terminal related to remote vehicle control according to the second example;

FIG. 14 is an explanatory view illustrating a situation where an external object is approaching a vehicle according to the second example;

FIG. 15 is a schematic diagram illustrating an in-vehicle perspective image of the second example;

FIG. 16 is a schematic diagram illustrating the mobile terminal displaying an in-vehicle perspective image according to the second example;

FIG. 17 is a flow chart illustrating an example of the flow of processing of the mobile terminal related to remote vehicle control according to a third example;

FIG. 18 is an explanatory view illustrating a situation where an object is in contact with the outside of a vehicle of the third example;

FIG. 19 is a schematic diagram illustrating an in-vehicle perspective image of the third example;

FIG. 20 is a schematic diagram illustrating the mobile terminal displaying the in-vehicle perspective image according to the third example;

FIG. 21 is an explanatory view illustrating a situation where there is a wall in the vicinity of a vehicle of a fourth example;

FIG. 22 is a schematic diagram illustrating an auxiliary image according to the fourth example;

FIG. 23 is a schematic diagram illustrating the mobile terminal displaying the auxiliary image according to the fourth example; and

FIG. 24 is a block diagram illustrating the configuration of a remote vehicle control system of a fifth example.

### DETAILED DESCRIPTION

Hereinafter, exemplary embodiments of the present invention will be described in detail with reference to the drawings. However, the present invention is not limited to the contents of the embodiments to be described below.

Also, in the following description, in the straight advancing direction of a vehicle, the direction from the driver's seat toward the steering wheel is referred to as the forward direction (the front side). In the straight advancing direction of the vehicle, the direction from the steering wheel toward the driver's seat is referred to as the backward direction (the rear side). In the direction perpendicular to the straight advancing direction of the vehicle and the vertical direction, the direction from the right side of the driver facing forward to the left side is referred to as the left direction. In the direction perpendicular to the straight advancing direction of the vehicle and the vertical direction, the direction from the left side of the driver facing forward to the right side is referred to as the right direction.

### 1. CONFIGURATION OF REMOTE VEHICLE CONTROL SYSTEM

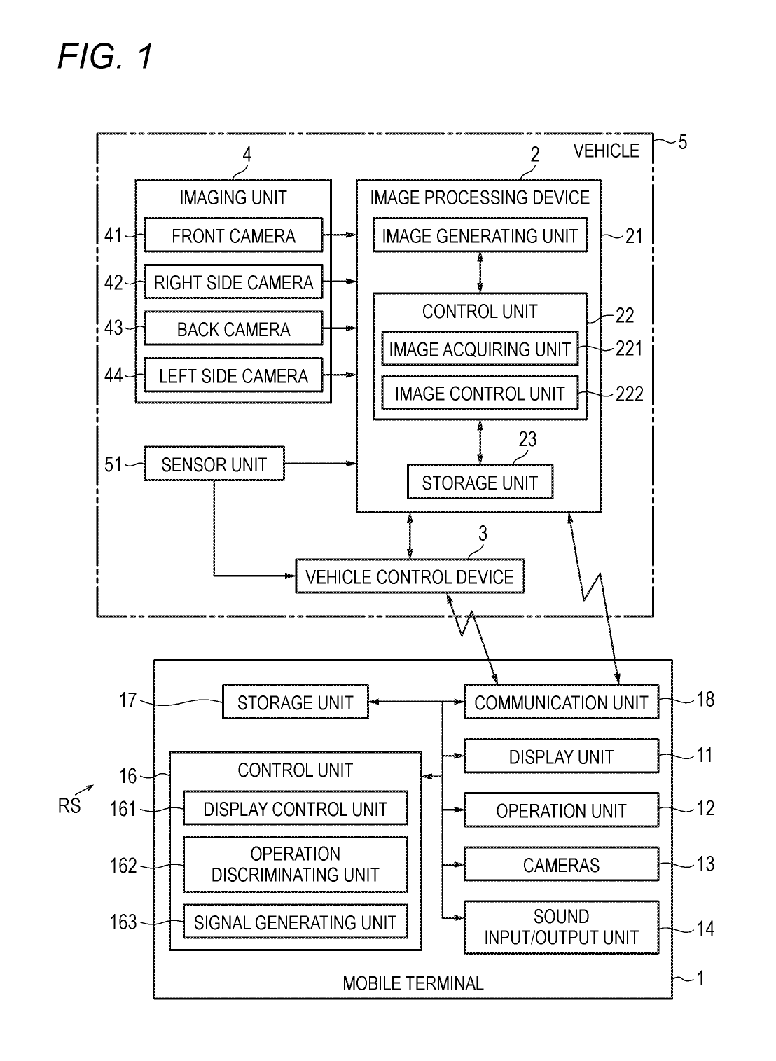

FIG. 1 is a block diagram illustrating the configuration of a remote vehicle control system RS of an embodiment. The remote vehicle control system RS includes a mobile terminal 1, an image processing device 2, and a vehicle control device 3. The mobile terminal 1 is a remote vehicle control device for remotely controlling a vehicle 5. The image processing device 2 and the vehicle control device 3 are mounted on the vehicle 5. The remote vehicle control system RS is a system for remotely controlling the vehicle 5 by the mobile terminal 1 capable of displaying synthetic images showing the surrounding area of the vehicle 5. The vehicle 5 further includes an imaging unit 4 (on-board cameras) and a sensor unit 51.

The mobile terminal 1 is a device configured to receive images for display which are output from the image processing device 2, and display the images, and transmits control signals to the vehicle 5, to remotely control the vehicle 5. Examples of the mobile terminal 1 include smart phones, tablet type terminals, and so on belonging to the owner of the vehicle 5 and so on. In the present embodiment, the mobile terminal 1 is, for example, a smart phone.

The image processing device 2 is a device configured to process images acquired by the on-board cameras. For each vehicle equipped with on-board cameras, an image processing device 2 is provided. In the present embodiment, the image processing device 2 acquires images from the imaging unit 4, and processes the images. Also, the image processing device 2 may acquire information from the sensor unit 51, and perform determinations related to image processing on the basis of the acquired information. Also, the image processing device 2 transmits information to the mobile terminal 1 and the vehicle control device 3, and receives information from them. The image processing device 2 may output images for display generated by the image processing device 2, to the mobile terminal 1.

The vehicle control device 3 performs control on the general operation of the vehicle. The vehicle control device 3 includes, for example, an engine ECU (Electronic Control Unit) for controlling the engine, a steering ECU for controlling the steering, a brake ECU for controlling the brake, a shift ECU for controlling the shift, a power source control ECU for controlling the power source, a light ECU for controlling the lights, a mirror ECU for controlling the electric mirrors, and so on. In the present embodiment, the vehicle control device 3 transmits information to the mobile terminal 1 and the image processing device 2, and receives information from them. The vehicle control device 3 receives control signals for the vehicle 5, from the mobile terminal 1, and controls the vehicle 5 on the basis of the control signals.

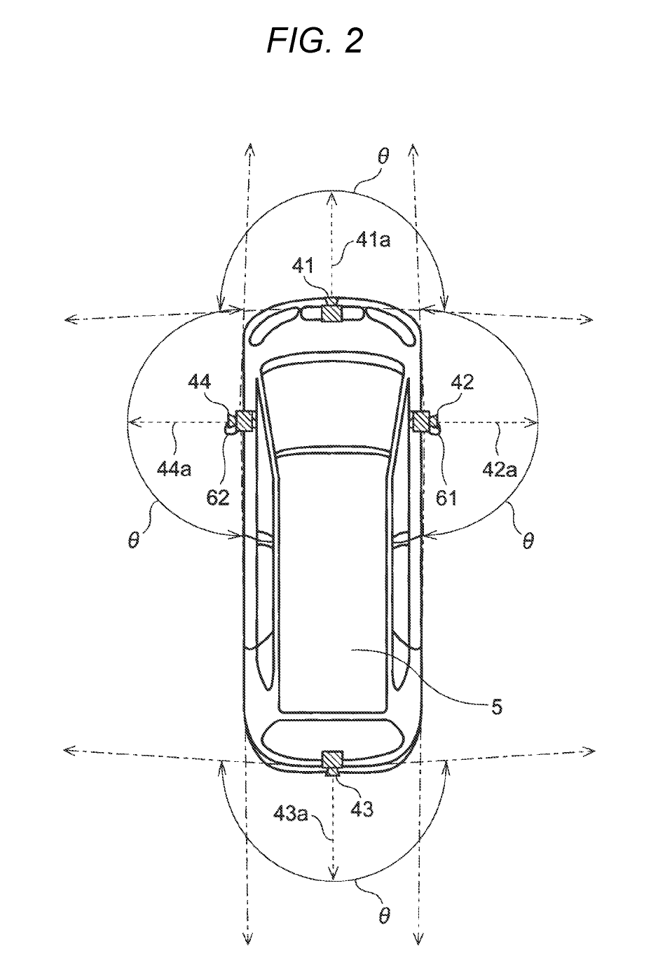

The imaging unit 4 is provided for monitoring the condition around the vehicle. The imaging unit 4 includes, for example, four on-board cameras 41 to 44. FIG. 2 is a view illustrating positions on the vehicle 5 where the on-board cameras 41 to 44 are disposed.

The on-board camera 41 is installed on the front end of the vehicle 5. Therefore, the on-board camera 41 is also referred to as the front camera 41. The optical axis 41a of the front camera 41 extends along the longitudinal direction of the vehicle 5 as seen in a plan view illustrating the vehicle as seen from the above. The front camera 41 images the area in front of the vehicle 5. The on-board camera 43 is installed on the rear end of the vehicle 5. Therefore, the on-board camera 43 is also referred to as the back camera 43. The optical axis 43a of the back camera 43 extends along the longitudinal direction of the vehicle 5 as seen in a plan view illustrating the vehicle as seen from the above. The back camera 43 images the area behind the vehicle 5. It is preferable that the installation positions of the front camera 41 and the back camera 43 be at the center in the width direction of the vehicle 5; however, the front camera and the back camera may be slightly deviated to the left or the right from the center in the width direction.

The on-board camera 42 is installed on a right mirror 61 of the vehicle 5. Therefore, the on-board camera 42 is also referred to as the right side camera 42. The optical axis 42a of the right side camera 42 extends along the width direction of the vehicle 5 as seen in a plan view illustrating the vehicle as seen from the above. The right side camera 42 images the area on the right side of the vehicle 5. The on-board camera 44 is installed on a left mirror 62 of the vehicle 5. Therefore, the on-board camera 44 is also referred to as the left side camera 44. The optical axis 44a of the left side camera 44 extends along the width direction of the vehicle 5 as seen in a plan view illustrating the vehicle as seen from the above. The left side camera 44 images the area on the left side of the vehicle 5.

However, in the case where the vehicle 5 is a so-called door-mirror-less vehicle, the right side camera 42 may be installed in the vicinity of the pivot (hinge part) of the right side door, without interposing a door mirror therebetween, and the left side camera 44 may be installed in the vicinity of the pivot (hinge part) of the left side door, without interposing a door mirror therebetween.

As lenses for the on-board cameras 41 to 44, for example, fisheye lenses are used. Each of the on-board cameras 41 to 44 has an angle of view θ equal to or greater than 180 degrees in the horizontal direction. Therefore, it is possible to image the area around the vehicle 5 in the horizontal direction.

FIG. 1 will be further described. The sensor unit 51 includes plural sensors for detecting information related to the vehicle 5 equipped with the on-board cameras 41 to 44. In information related to the vehicle 5, information on the vehicle and information on the surrounding area of the vehicle may be included. In the present embodiment, in the sensor unit 51, for example, a vehicle velocity sensor for detecting the velocity of the vehicle, a steering angle sensor for detecting the rotation angle of the steering, a shift sensor for detecting the operation position of the shift lever of the transmission of the vehicle, an illuminance sensor for detecting the illuminance in the surrounding area of the vehicle, a vibration sensor for detecting vibration of the vehicle, a tilt sensor for detecting the tilt of the vehicle, obstacle sensors for detecting people, animals, vehicles, and other objects in the surrounding area of the vehicle, and so on are included.

The obstacle sensors may use, for example, ultrasonic sensors, light sensors using infrared light or the like, radars, and the like to detect people, animals, vehicles, and other objects in the surrounding area of the vehicle. The obstacle sensors are embedded at plural positions, for example, in the front bumper, the rear bumper, the doors, and so on of the vehicle 5. The obstacle sensors transmit transmission waves toward the surrounding area of the vehicle, and receive waves reflected from people, other vehicles, and so on, to detect whether there are objects such as people, other vehicles, and so on, and the directions and positions of objects.

### 2. CONFIGURATION OF MOBILE TERMINAL

The mobile terminal 1 is configured to include a display unit 11, an operation unit 12, cameras 13, a sound input/output unit 14, a control unit 16, a storage unit 17, and a communication unit 18.

The display unit 11 is disposed on the front surface of the mobile terminal 1 which is a smart phone. In the present embodiment, the display unit 11 has a touch panel, as a part of the operation unit 12, on the front surface, and the touch panel is, for example, a liquid crystal display panel. The display unit 11 displays, for example, images for display output from the image processing device 2, on the screen.

The operation unit 12 includes, for example, the touch panel provided on the front surface of the display unit 11, other operation buttons, and so on. The operation unit 12 is configured such that a user may input information from the outside, i.e. the user may perform operations such as operations of inputting characters, numbers, and so on, operations of selecting a menu or a choice, and operations for performing or canceling a process. In the present embodiment, the operation unit 12 is a touch panel usable to operate the vehicle 5. However, the operation unit 12 is not limited to software keys using a touch panel or the like, and may be hardware keys provided as physical input units on the mobile terminal 1.

The cameras 13 are disposed on the front surface and rear surface of the mobile terminal 1 which is a smart phone. The front camera 13 images the front surface side of the surrounding area of the mobile terminal 1. The rear camera 13 images the rear surface side of the surrounding area of the mobile terminal 1.

The sound input/output unit 14 includes, for example, a microphone and a speaker. The microphone acquires information on sounds around the mobile terminal 1, including sound which is uttered by the user. The speaker emits notifying sound, sound on a communication line, and so on to the outside.

The control unit 16 is a so-called microcomputer including a CPU (Central Processing Unit), a RAM (Random Access Memory), and a ROM (Read Only Memory) (not shown in the drawings). The control unit 16 performs information processing and information transmission and reception on the basis of a program stored in the storage unit 17. The control unit 16 is connected to the display unit 11, the operation unit 12, the cameras 13, the sound input/output unit 14, the storage unit 17, and the communication unit 18 by wire.

The control unit 16 includes a display control unit 161, an operation discriminating unit 162, and a signal generating unit 163. The CPU performs arithmetic processing according to a program, whereby the functions of the individual components of the control unit 16 are implemented.

The display control unit 161 controls display contents of the display unit 11. For example, if receiving inputs for performing and setting various functions of the mobile terminal 1, the display control unit 161 controls the display unit 11 such that the display unit displays function images related to the functions. The function images are images corresponding to various functions of the mobile terminal 1, and includes, for example, icons, buttons, software keys, slide bars, slide switches, check boxes, text boxes, and so on. The user may select the function images displayed on the display unit 11 by touching the touch panel (the operation unit 12), thereby performing and setting various functions of the mobile terminal 1.

The operation discriminating unit 162 receives detection signals output from the touch panel (the operation unit 12), and discriminates the contents of operations performed on the touch panel, on the basis of the detection signals. The operation discriminating unit 162 discriminates operations such as tapping, dragging, flicking, and so on, besides information on positions on the touch panel. In the case of operations using moving, such as dragging and flicking, the operation discriminating unit also discriminates the movement directions, the movement distances, and so on.

The signal generating unit 163 generates control signals for the vehicle 5, on the basis of operations on the operation unit 12. The generated control signals for the vehicle 5 are transmitted to the vehicle 5 via the communication unit 18.

The storage unit 17 is a non-volatile memory such as a flash memory, and stores a variety of information. The storage unit 17 stores, for example, programs which are firmware, a variety of data necessary for the control unit 16 to perform various functions, and so on.

The communication unit 18 may be connected to various external devices, for example, wirelessly. The mobile terminal 1 may receive images for display generated by the image processing device 2 of the vehicle 5, and a variety of information (the steering angle, the shift position, the traveling velocity, obstacle information, and so on) detected by the sensor unit 51 of the vehicle 5, via the communication unit 18. The mobile terminal 1 may transmit control signals for the vehicle 5 based on operations on the operation unit 12, to the vehicle 5 via the communication unit 18.

### 3. CONFIGURATION OF IMAGE PROCESSING DEVICE

The image processing device 2 is configured to include an image generating unit 21, a control unit 22, and a storage unit 23.

The image generating unit 21 generates images for display by processing images acquired by the imaging unit 4. In the present embodiment, the image generating unit 21 is configured as a hardware circuit capable of a variety of image processing. In the present embodiment, the image generating unit 21 generates synthetic images showing the surrounding area of the vehicle 5 as seen from virtual viewpoints, on the basis of images acquired by the on-board cameras 41 to 44 mounted on the vehicle 5. Further, the image generating unit 21 generates images for display to be displayed on the mobile terminal 1, on the basis of the synthetic images. Details of the method of generating synthetic images will be described below.

The control unit 22 is a so-called microcomputer including a CPU, a RAM, and a ROM (not shown in the drawings). The control unit 22 performs information processing and information transmission and reception on the basis of a program stored in the storage unit 23. The control unit 22 is connected to the mobile terminal 1, the vehicle control device 3, the imaging unit 4, and the sensor unit 51 by wire or wirelessly.

The control unit 22 includes an image acquiring unit 221 and an image control unit 222. The CPU performs arithmetic processing according to a program, whereby the functions of the individual components of the control unit 22 are implemented.

The image acquiring unit 221 acquires images acquired by the on-board cameras 41 to 44. In the present embodiment, the number of on-board cameras 41 to 44 is four, and the image acquiring unit 221 acquires images acquired by the individual on-board cameras 41 to 44.

The image control unit 222 controls image processing which is performed by the image generating unit 21. For example, the image control unit 222 issues instructions related to various parameters necessary to generate synthetic images and images for display, to the image generating unit 21. Also, the image control unit 222 performs control to output images for display generated by the image generating unit 21 to the mobile terminal 1. However, in this description, images for display which are related to synthetic images and are displayed on the display unit 11 of the mobile terminal 1 are also referred to simply as synthetic images.

The storage unit 23 is a non-volatile memory such as a flash memory, and stores a variety of information. The storage unit 23 stores, for example, programs which are firmware, a variety of data necessary for the image generating unit 21 to generate synthetic images and images for display. Also, the storage unit 23 stores a variety of data necessary for the image acquiring unit 221 and the image control unit 222 to perform processing.

### 4. GENERATION OF SYNTHETIC IMAGES

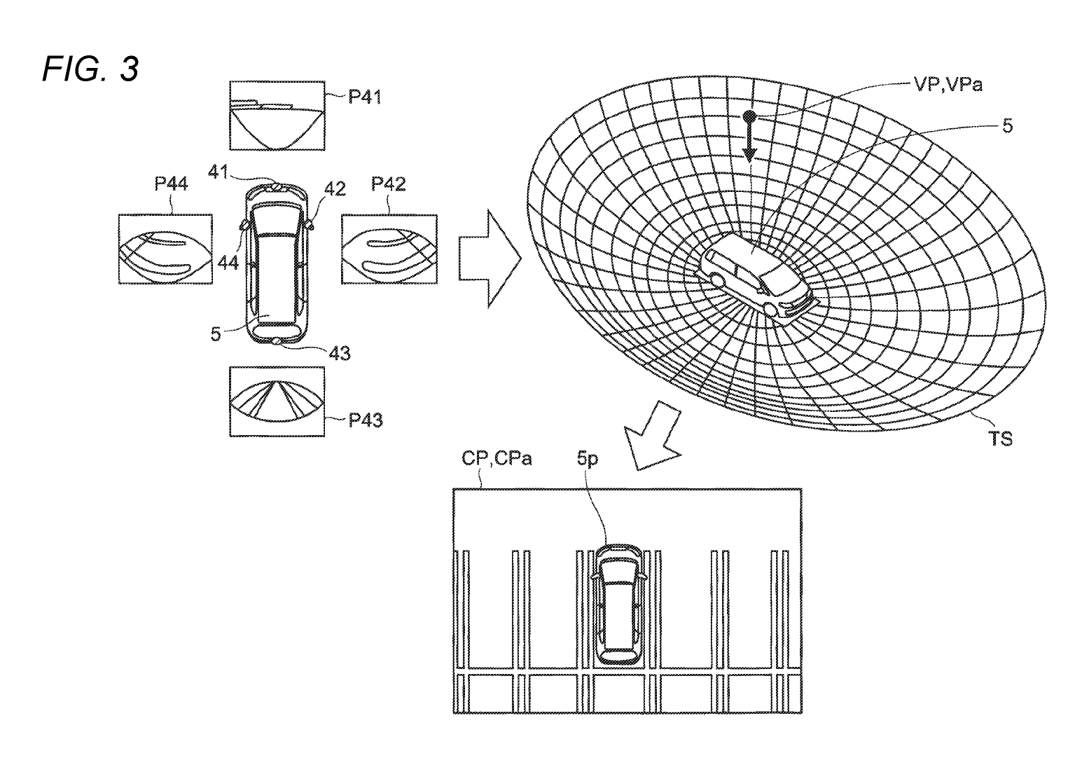

The method by which the image generating unit 21 generates synthetic images showing the condition in the surrounding area of the vehicle 5 as seen from virtual viewpoints will be described. FIG. 3 is a view for explaining the method of generating synthetic images CP showing the surrounding area of the vehicle 5.

By the front camera 41, the right side camera 42, the back camera 43, and the left side camera 44, four images P41 to P44 showing the front side, the right side, the rear side, and the left side of the vehicle 5 respectively are acquired at the same time. In the four images P41 to P44, data on all over the surrounding area of the vehicle 5 is included. The image generating unit 21 acquires the four images P41 to P44 via the image acquiring unit 221.

The image generating unit 21 projects the data included in the four images P41 to P44 (the values of the individual pixels), onto a projection plane TS which is a three-dimensional curved plane in a virtual three-dimensional space. The projection plane TS has, for example, a substantially hemispherical shape (a bowl shape), and the center thereof (a bottom part of the bowl) is determined as the position of the vehicle 5.

Onto an area of the projection plane TS on the outside of the area for the vehicle 5, the image data is projected. The correspondence relation between the positions of the individual pixels which are included in the images P41 to P44 and the positions of the individual pixels on the projection plane TS is determined in advance. Table data representing that correspondence relation is stored in the storage unit 23. The values of the individual pixels on the projection plane TS may be determined on the basis of the above-mentioned correspondence relation and the values of the individual pixels included in the images P41 to P44.

Next, the image generating unit 21 sets a virtual viewpoint VP in the three-dimensional space under the control of the image control unit 222. The virtual viewpoint VP is defined by a viewpoint position and a sight line direction. The image generating unit 21 may set a virtual viewpoint VP having an arbitrary viewpoint position and an arbitrary sight line direction, in the three-dimensional space. The image generating unit 21 extracts data projected onto an area of the projection plane TS included in the field of view as seen from the set virtual viewpoint VP, as an image. In this way, the image generating unit 21 generates synthetic images as seen from arbitrary virtual viewpoints VP.

For example, as shown in FIG. 3, in the case of assuming a virtual viewpoint VPa defined by a viewpoint position which is right above the vehicle 5 and a sight line direction which is a straight downward direction, it is possible to generate a synthetic image (a bird's eye view image) CPa showing the vehicle 5 and the surrounding area of the vehicle 5.

An image 5p of the vehicle 5 which is shown in the synthetic image CPa is prepared as data such as a bitmap and is stored in the storage unit 23, in advance. When the synthetic image CPa is generated, the data of the image 5p of the vehicle 5 having a shape according to the viewpoint position and the sight line direction defining the virtual viewpoint VP of the synthetic image is read out, and is included in the synthetic image CPa.

As described above, the image generating unit 21 may generate realistic synthetic images CPa, using the virtual three-dimensional projection plane TS.

Also, it is possible to check the surrounding area of the vehicle 5, using each synthetic image CP showing the surrounding area of the vehicle 5, generated on the basis of plural images acquired by the plural on-board cameras 41 to 44 mounted on the vehicle 5. Therefore, it is also possible to check blind areas from the position of the user, such as an area on the opposite side of the vehicle 5 screened by the vehicle 5 as seen from the position of the user.

### First Example

### 5. EXAMPLES OF REMOTE VEHICLE CONTROL USING MOBILE TERMINAL

### 5-1. First Example

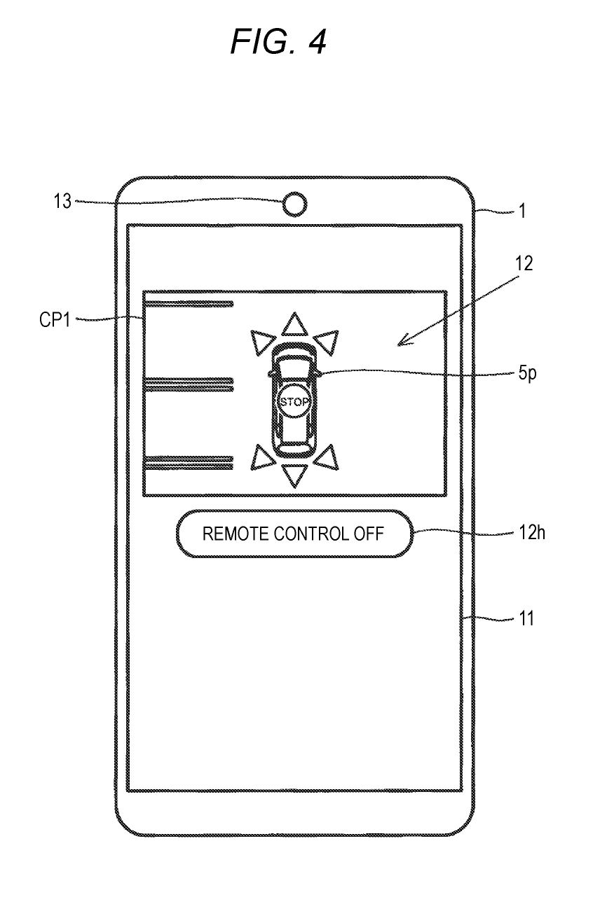

The mobile terminal 1 may receive bird's eye view images which are a type of synthetic images showing the surrounding area of the vehicle 5 as seen from virtual viewpoints, generated by the image processing device 2 of the vehicle 5. The mobile terminal 1 may display the bird's eye view images on the display unit 11. FIG. 4 is a schematic diagram illustrating the mobile terminal 1 displaying a bird's eye view image CP1 according to a first example.

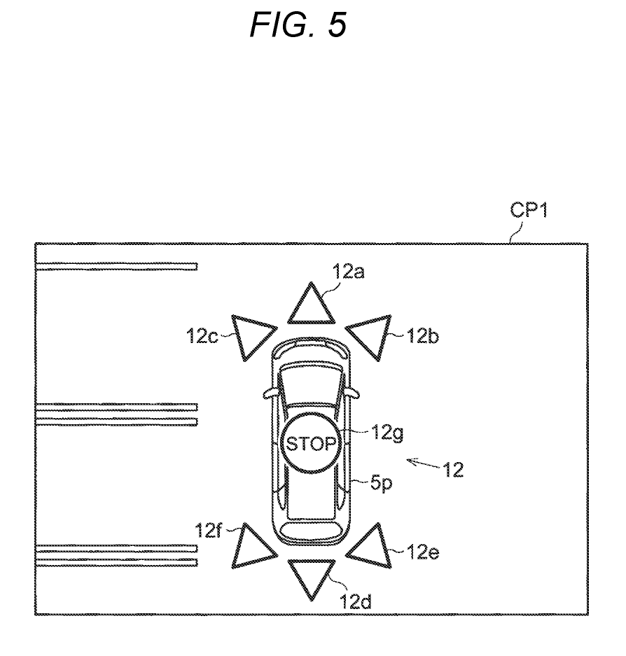

FIG. 5 is a schematic diagram illustrating the bird's eye view image CP1 displayed on the mobile terminal 1 according to the first example. As shown in FIG. 5, on the occasion of remotely controlling the vehicle 5, the mobile terminal 1 displays icons and so on which are function images related to remote control on the vehicle 5, on the display unit 11. In other words, on the bird's eye view image CP1, icons and so on which are images of the operation unit 12 are superimposed. The operation unit 12 is disposed according to the position of the image 5p of the vehicle 5 on the bird's eye view image CP1.

Specifically, on the screen of the display unit 11, for example, an icon 12a related to forward traveling, an icon 12b related to the front right side, an icon 12c related to the front left side, an icon 12d related to backward traveling, an icon 12e related to the rear right side, and an icon 12f related to the rear left side are displayed so as to overlap the bird's eye view image CP1. These icons related to traveling of the vehicle 5 are disposed, for example, around the image 5p of the vehicle 5, according to positions and directions corresponding to individual traveling directions, respectively. In the present example, the icons indicating the traveling directions of the vehicle 5 are configured, for example, in a triangular shape; however, they may be configured in any other shape such as an arrow shape.

Also, a “STOP” icon 12g related to stopping of the vehicle 5 is disposed so as to overlap the image 5p of the vehicle 5. Further, outside the bird's eye view image CP1, an icon 12h for ending remote control on the vehicle 5 is displayed.

The user may arbitrarily operate the icons with fingers. The operation discriminating unit 162 discriminates the contents of operations corresponding to the icons on the basis of detection signals of the touch panel (the operation unit 12). The signal generating unit 163 generates control signals for the vehicle 5, on the basis of the operation contents corresponding to the icons. The control signals are transmitted to the vehicle 5 via the communication unit 18.

For example, if the user presses (touches) the icon 12a related to forward traveling of the vehicle 5 once, the vehicle 5 travels forward by a predetermined distance (for example, 10 cm). Also, for example, if the user presses the icon 12c related to the front left side of the vehicle 5, the vehicle 5 changes the steering angle by a predetermined angle such that the vehicle travels to the front left side. In this configuration, whenever changing the steering angle, the orientation of the image 5p of the vehicle 5 may be changed such that it is possible to easily grasp which direction the vehicle is turning to. Subsequently, if the user presses the icon 12a related to forward traveling once, the vehicle 5 travels to the front left side by a predetermined distance. However, the movement direction, traveling distance, and so on may be controlled on the basis of operations using moving which is performed on the touch panel (the operation unit 12), such as dragging and flicking.

In the case where the user wants to stop the vehicle 5 when the vehicle is traveling, if the user presses the “STOP” icon 12g related to stopping of the vehicle 5, the vehicle 5 stops. Alternatively, the vehicle 5 may travel only when the user is pressing the icon 12a related to forward traveling or the icon 12d related to backward traveling, and if the user removes the finger from the icon 12a or the icon 12d, the vehicle 5 may stop.

Further, the user may perform operations such as an operation for changing the viewpoint position, the sight line direction, and the zoom related to a synthetic image displayed on the display unit 11, via the operation unit 12.

During remote control, obstacles around the vehicle 5, such as people, animals, vehicles, and other objects, are detected by the sensor unit 51 of the vehicle 5. If the sensor unit 51 detects any obstacle, a detection signal is transmitted to the vehicle control device 3, and the vehicle control device 3 automatically stops the vehicle 5.

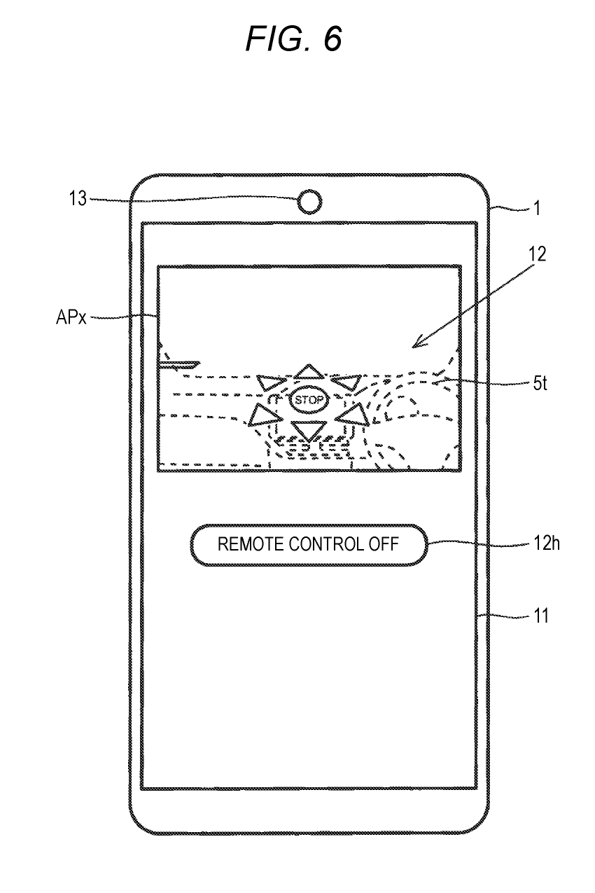

Also, if the image processing device 2 of the vehicle 5 generates an in-vehicle perspective image including an transparent image 5t as an image of the vehicle 5, on the basis of a viewpoint position which is a predetermined position inside the vehicle 5 and a sight line direction which is the direction from the viewpoint position toward the outside of the vehicle 5, the mobile terminal 1 may receive the generated in-vehicle perspective image via the communication unit 18. The mobile terminal 1 may display the in-vehicle perspective image on the display unit 11. FIG. 6 is a schematic diagram illustrating the mobile terminal 1 displaying an in-vehicle perspective image APx according to the first example.

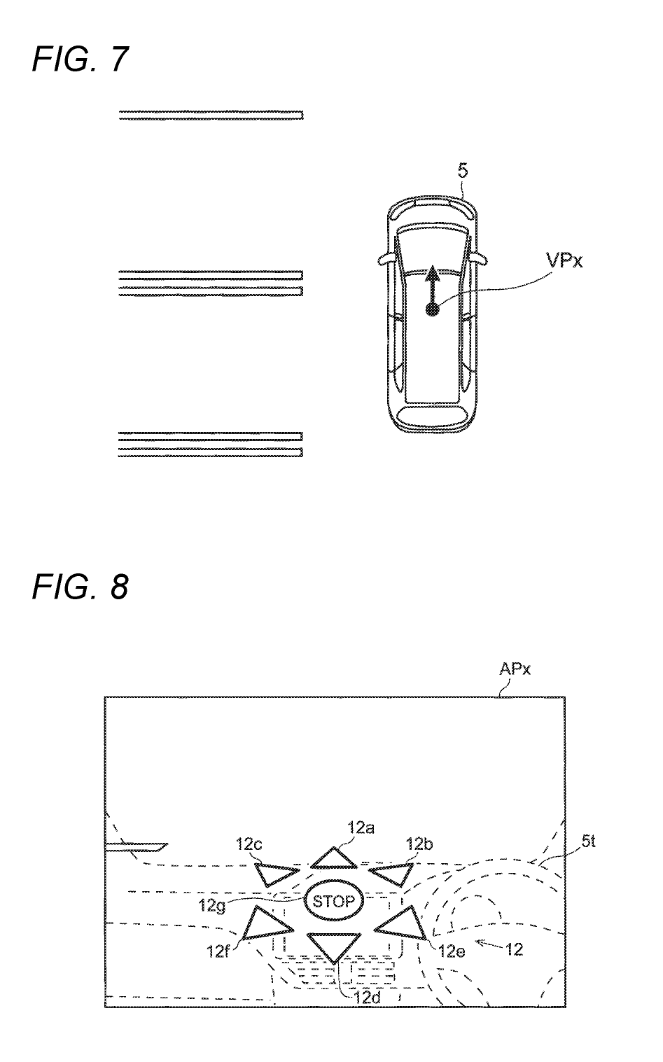

FIG. 7 is an explanatory view illustrating a virtual viewpoint VPx related to the in-vehicle perspective image APx according to the first example. The in-vehicle perspective image APx is an image of the outside of the vehicle 5 based on a virtual viewpoint VPx defined by a viewpoint position which is a predetermined position inside the vehicle 5 and is close to the viewpoint of the driver and a sight line direction which is a direction from the viewpoint position toward the front side of the left side of the vehicle 5.

FIG. 8 is a schematic diagram illustrating the in-vehicle perspective image APx according to the first example. In the in-vehicle perspective image APx, in the synthetic image generated by the image generating unit 21, the transparent image 5t of the vehicle 5 may be included. In the case where the viewpoint position of the virtual viewpoint is inside the vehicle 5, the in-vehicle perspective image APx is an image showing a situation closer to the actual view which is seen in the sight line direction, so it is easy to understand the positional relationship between the vehicle 5 and objects around the vehicle. In the in-vehicle perspective image APx, in order to prevent objects around the vehicle 5 from being screened by a part of the vehicle 5, as an image of the vehicle 5, the transparent image 5t is shown.

The transparent image 5t of the vehicle 5 which is shown in the in-vehicle perspective image APx is prepared as data such as a bitmap, and is stored in the storage unit 23, in advance. When the in-vehicle perspective image APx is generated, the data of the transparent image 5t having a shape according to the viewpoint position and the sight line direction defining the virtual viewpoint VPx of the in-vehicle perspective image is read out, and is included in the in-vehicle perspective image.

However, the transparent image 5t of the vehicle 5 does not need to be included over the whole in-vehicle perspective image APx. The transparent image 5t of the vehicle 5 may be included in only a part of the whole in-vehicle perspective image APx, for example, an area having a predetermined size including the sight line direction.

Also, in the present example, the transparent image 5t of the vehicle 5 in the in-vehicle perspective image APx is a three-dimensional semi-transparent image representing the vehicle 5. According to this configuration, it is possible to superimpose the transparent image 5t representing the structure of the vehicle 5 on an image showing the condition outside the vehicle. Therefore, it becomes possible to easily grasp directions and positional relationships in the condition outside the vehicle, included in the in-vehicle perspective image APx.

Similarly to the bird's eye view image CP1, on the in-vehicle perspective image APx, the icons and so on which are images of the operation unit 12 are superimposed. The operation unit 12 is disposed according to the position of the transparent image 5t of the vehicle 5 on the in-vehicle perspective image APx. On the screen of the display unit 11, for example, the icon 12a related to forward traveling, the “STOP” icon 12g related to stopping of the vehicle 5, and so on are disposed so as to overlap the transparent image 5t of the vehicle 5 included in the in-vehicle perspective image APx.

Also, the mobile terminal 1 has two display modes, i.e. a normal mode for displaying a bird's eye view image CP1 on the display unit 11 on the occasion of remotely controlling the vehicle 5 and a transparency mode for displaying an in-vehicle perspective image APx on the display unit 11 on the occasion of remotely controlling the vehicle. The user may arbitrarily select one mode to be used, from the two display modes, via the operation unit 12.

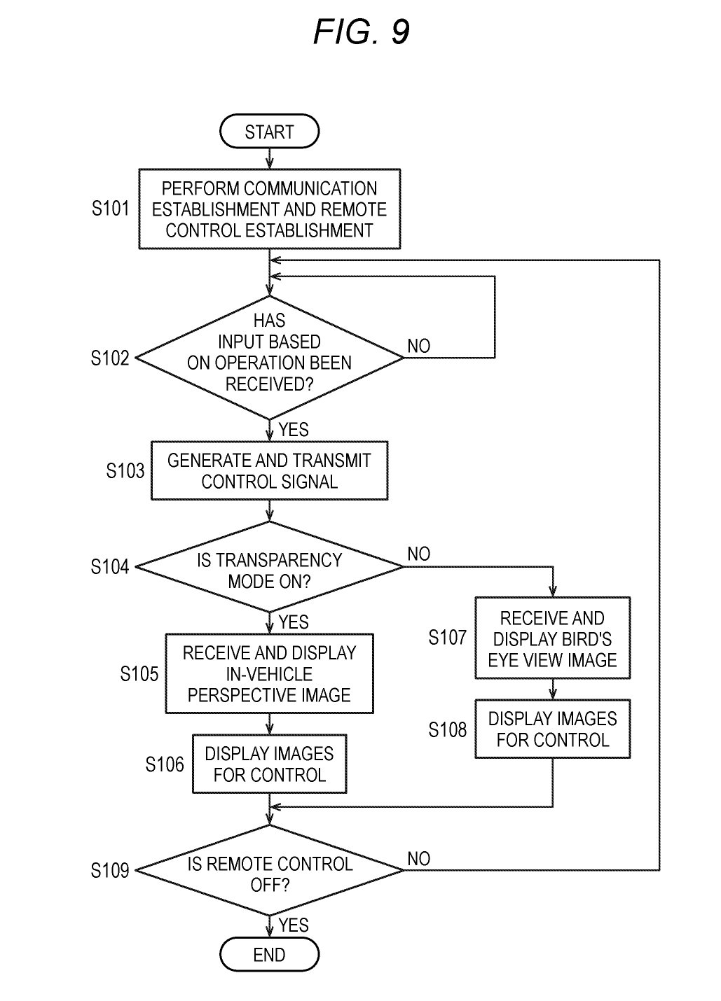

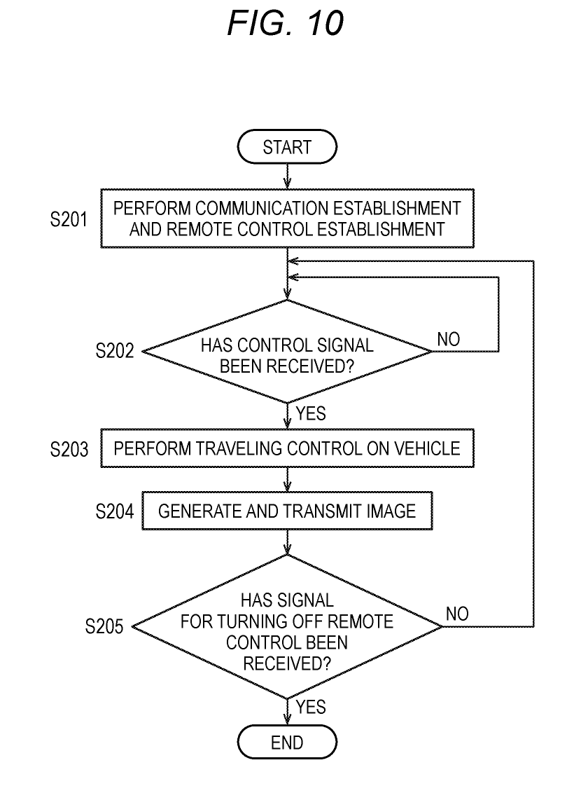

FIG. 9 is a flow chart illustrating an example of the flow of processing of the mobile terminal 1 related to remote vehicle control according to the first example. FIG. 10 is a flow chart illustrating another example of the flow of processing of the mobile terminal 1 related to remote vehicle control according to the first example. The processing which is related to remote control on the vehicle 5 and is performed by the mobile terminal 1 according to the first example will be described with reference to the processing flows of FIG. 9 and FIG. 10.

For example, if the mobile terminal 1 is operated by the user, and receives an remote control start instruction from the operation unit 12, the processing of the mobile terminal 1 related to remote control on the vehicle 5 is started (“START” of FIG. 9). Remote control on the vehicle 5 is started when the vehicle 5 is stopped.

Subsequently, the mobile terminal 1 performs a communication establishment process and a remote control establishment process in cooperation with the vehicle 5 (STEP S101). At this time, even in the vehicle 5, processing related to remote control is started (“START” of FIG. 10), and the communication establishment process and the remote control establishment process are performed in cooperation with the mobile terminal 1 (STEP S201). In these steps, for example, a process of matching the mobile terminal 1 and the vehicle 5, a control permission process, and so on are performed. In the control permission process, for example, an authentication process on an ID, a password, and so on is performed.

Next, the mobile terminal 1 determines whether an input based on a user's operation on the operation unit 12 has been received (STEP S102 of FIG. 9). Examples of a user's operation include an operation for performing remote control related to traveling of the vehicle 5, an operation for changing the viewpoint position, the sight line direction, or the zoom related to an image, an operation for selecting a display means, and so on.

In the case where an input based on an operation on the operation unit 12 has been received (“Yes” in STEP S102 of FIG. 9), the mobile terminal 1 generates a control signal based on the operation on the operation unit 12 by the signal generating unit 163, and transmits the control signal to the vehicle 5 (STEP S103). In this way, the user may perform remote control on the vehicle 5.

In the vehicle 5, whether any control signal related to remote control on the vehicle 5 has been received is determined (STEP S202 of FIG. 10). In the case where the vehicle 5 has received a control signal (“Yes” in STEP S202), for example, if the control signal is a signal related to traveling control, the vehicle control device 3 controls traveling of the vehicle 5 on the basis of the control signal (STEP S203).

In the case where the control signal received by the vehicle 5 is a signal related to image generation, the image processing device 2 generates an image on the basis of the control signal, and transmits the image to the mobile terminal 1 (STEP S204). The image processing device 2 acquires images of the surrounding area of the vehicle 5 from the on-board cameras 41 to 44, respectively. The image generating unit 21 generates a synthetic image showing the surrounding area of the vehicle 5 as seen a virtual viewpoint, on the basis of the plural images of the surrounding area of the vehicle 5. Also, the image generating unit 21 generates a bird's eye view image CP1 and an in-vehicle perspective image APx related to the synthetic image.

Next, with respect to selection of a display mode for the display unit 11, the mobile terminal 1 determines whether an operation for turning on the transparency mode has been printed (STEP S104 of FIG. 9). With respect to the display modes for the display unit 11, the user may arbitrarily select whether to turn on or off the transparency mode.

In the case where the transparency mode is on (“Yes” in STEP S104), the mobile terminal 1 receives the in-vehicle perspective image APx from the image processing device 2, and displays the in-vehicle perspective image APx on the display unit 11 (STEP S105). Subsequently, the mobile terminal 1 displays the icons and so on (the operation unit 12) which are function images related to the control on the vehicle 5, on the display unit 11, so as to overlap the in-vehicle perspective image APx (STEP S106). As a result, the user may arbitrarily operate the icons for remote control with fingers.

In the case where the transparency mode is off (“No” in STEP S104), the mobile terminal 1 receives the bird's eye view image CP1 from the image processing device 2, and displays the bird's eye view image CP1 on the display unit 11 (STEP S107). Subsequently, the mobile terminal 1 displays the icons and so on (the operation unit 12) which are function images related to the control on the vehicle 5, on the display unit 11, so as to overlap the bird's eye view image CP1 (STEP S108). As a result, the user may arbitrarily operate the icons for remote control with fingers.

Next, the mobile terminal 1 determines whether an operation for turning off remote control on the vehicle 5 has been performed by the user (STEP S109). The user may end remote control on the vehicle 5 by operating the icon 12h for ending remote control on the vehicle 5. In the case where an operation for turning off remote control has not been performed (“No” in STEP S109), the mobile terminal 1 returns to STEP S102, and carries on determining whether an input based on a user's operation has been received.

In the case where an operation for turning off remote control has been performed (“Yes” in STEP S109), the processing flow of the mobile terminal 1 shown in FIG. 9 is ended.

In the vehicle 5, whether a control signal for turning off remote control on the vehicle 5 has been received is determined (STEP S205 of FIG. 10). In the case where a control signal for turning off remote control has not been received (“No” in STEP S205), the vehicle returns to STEP S202, and carries on determining whether a control signal related to remote control on the vehicle 5 has been received.

In the case where a control signal for turning off remote control has been received (“Yes” in STEP S205), the processing flow of the vehicle 5 shown in FIG. 10 is ended.

As described above, the mobile terminal 1 of the present example which is a remote vehicle control device displays the in-vehicle perspective image APx including the transparent image 5t as an image of the vehicle 5, generated on the basis of the viewpoint position which is a predetermined position inside the vehicle 5 and the sight line direction which is the direction from the viewpoint position toward the outside of the vehicle 5, on the display unit 11. The communication unit 18 transmits control signals for the vehicle 5, to the vehicle 5. According to this configuration, the user may perform remote control on the vehicle 5 while checking the condition outside the vehicle 5 as seen from the inside of the vehicle 5, on the in-vehicle perspective image APx. In other words, the user may perform remote control on the vehicle 5 on the basis of the in-vehicle perspective image APx showing a situation close to the actual view which is seen from the inside of the vehicle 5. In other words, it becomes easier to understand the directions and positional relationship of objects around the vehicle 5, and it is possible to improve convenience and operability in remote control on the vehicle 5.

Further, the communication unit 18 receives the in-vehicle perspective image APx generated in the vehicle 5, from the vehicle 5. According to this configuration, it is possible to reduce the load of the mobile terminal 1. Therefore, it is possible to perform remote control using the mobile terminal 1, quickly and stably, and it is possible to improve convenience and operability in remote control on the vehicle 5.

Also, control signals for the vehicle 5 include signals related to control on the viewpoint positions and sight line directions of in-vehicle perspective images APx. According to this configuration, the user may see in-vehicle perspective images APx based on various arbitrary viewpoint positions and various arbitrary sight line directions. Therefore, it is possible to improve convenience and operability in remote control on the vehicle 5.

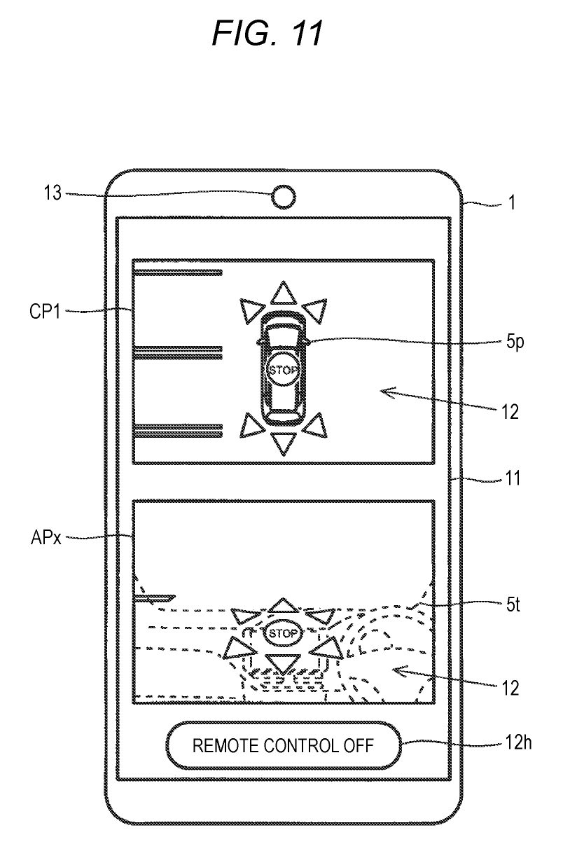

Also, FIG. 11 is a schematic diagram illustrating the mobile terminal 1 displaying a bird's eye view image CP1 and an in-vehicle perspective image APx according to the first example. As shown in FIG. 11, a bird's eye view image CP1 and an in-vehicle perspective image APx may be displayed on the display unit 11 so as to be aligned in the vertical direction, at the same time. In this case, the user may arbitrarily select an image easy to operate, and perform remote control. The arrangement of a synthetic image CP1 and an in-vehicle perspective image APx in the vertical direction may be changed appropriately and arbitrarily.

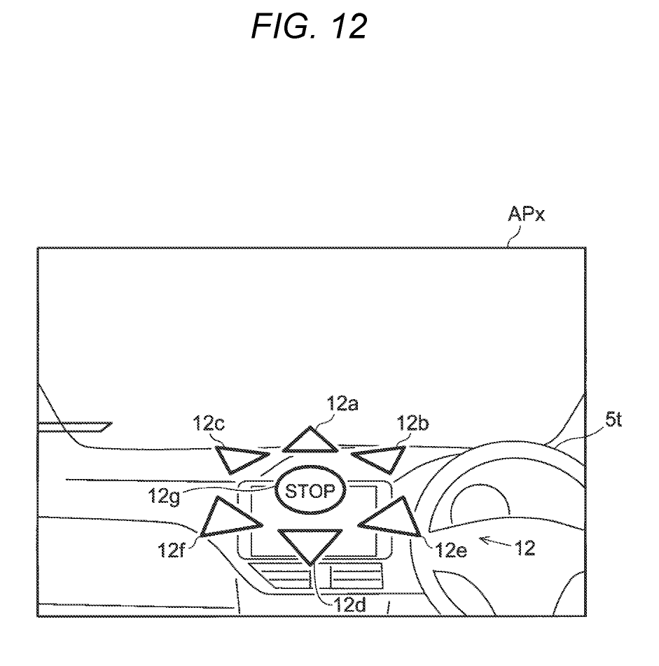

Also, FIG. 12 is a schematic diagram illustrating an in-vehicle perspective image APx of a second example. As shown in FIG. 12, in the present example, a transparent image 5t of the vehicle 5 in an in-vehicle perspective image APx is a wireframe image configured with a set of lines representing sides of a three-dimensional shape representing the vehicle 5. According to this configuration, it is possible to superimpose a transparent image 5t representing the structure of the vehicle 5 on an image showing the condition outside the vehicle. Therefore, it becomes possible to easily grasp directions and positional relationships in the condition outside the vehicle, included in an in-vehicle perspective image APx.

### Second Example

### 5-2. Second Example

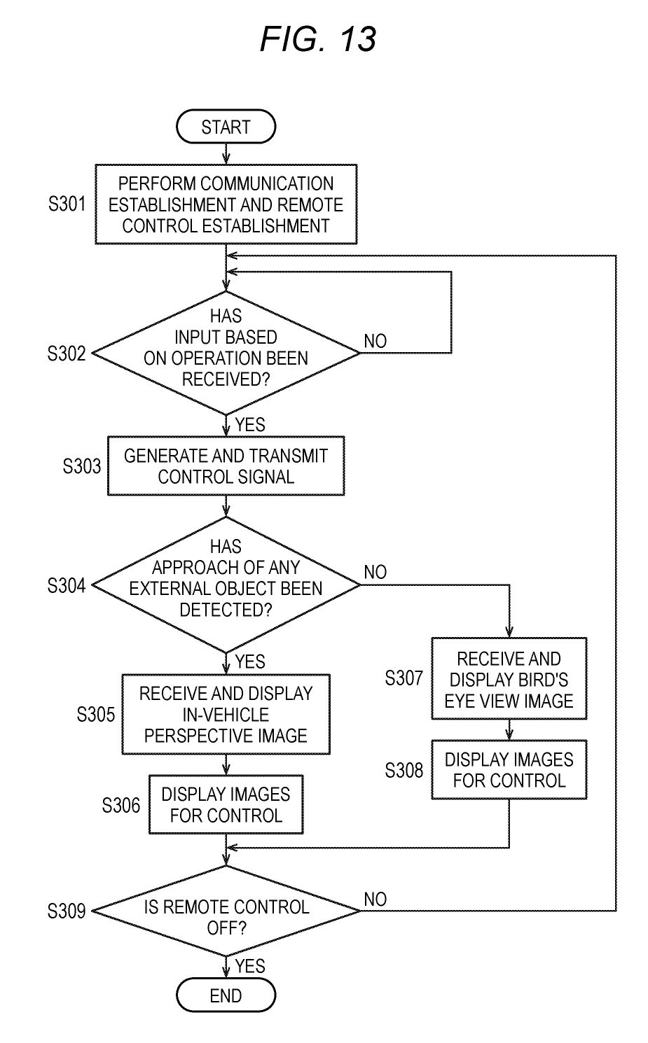

FIG. 13 is a flow chart illustrating an example of the flow of processing of the mobile terminal 1 related to remote vehicle control according to the second example. The processing which is related to remote control on the vehicle 5 and is performed by the mobile terminal 1 according to the second example will be described with reference to FIG. 13. However, since the flow of processing of the vehicle 5 is identical to FIG. 10 described in the first example, a description thereof will not be made. Also, since the flow of processing of the mobile terminal 1 shown in FIG. 13 is identical to FIG. 9 described in the first example, a description thereof will not be made.

For example, if the mobile terminal 1 is operated by the user, and receives a remote control start instruction from the operation unit 12, the processing of the mobile terminal 1 related to remote control on the vehicle 5 is started (“START” of FIG. 13). Remote control on the vehicle 5 is started when the vehicle 5 is stopped.

Next, the mobile terminal 1 performs a communication establishment process and a remote control establishment process in cooperation with the vehicle 5 (STEP S301). Subsequently, the mobile terminal 1 determines whether an input based on a user's operation on the operation unit 12 has been received (STEP S302). In the case where an input based on an operation on the operation unit 12 has been received (“Yes” in STEP S302), the mobile terminal 1 generates a control signal on the basis of the operation on the operation unit 12 by the signal generating unit 163, and transmits the control signal to the vehicle 5 (STEP S303).

Next, whether approach of any external object to the vehicle 5 has been detected is determined (STEP S304). Approach of any external object to the vehicle 5 is determined, for example, by determining whether the object is in a predetermined range from the vehicle 5. An arbitrary range such as a range up to 3 m in the radial direction may be set as the predetermined range from the vehicle 5. People, animals, vehicles, and other objects around the vehicle 5 are detected, for example, on the basis of detection signals of the ultrasonic sensors, the light sensors, and the radars included in the sensor unit 51, or image recognition using images of the on-board cameras 41 to 44.

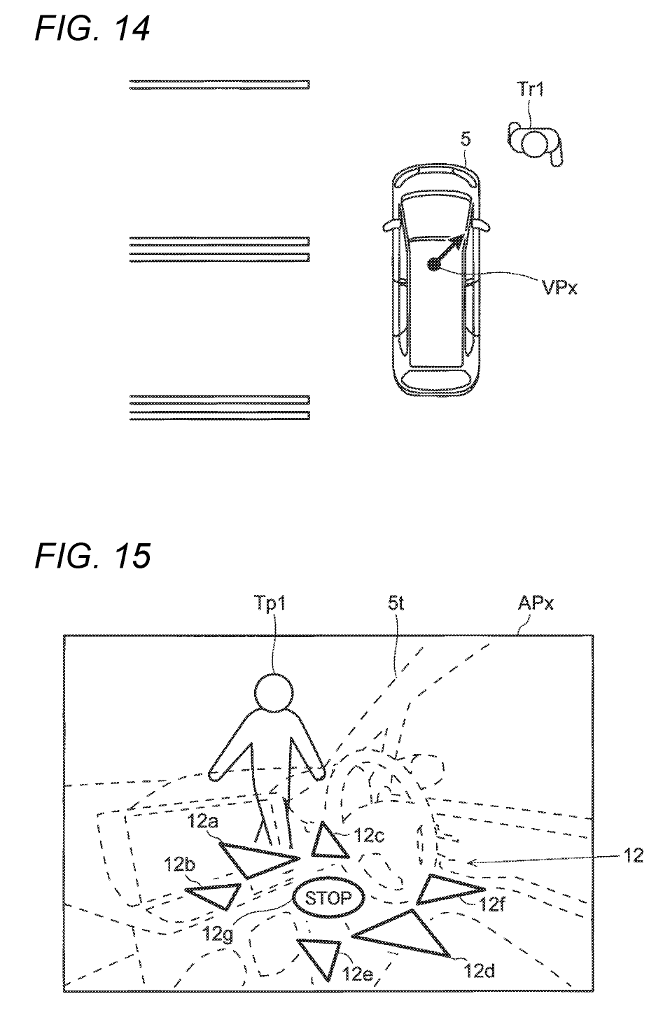

In the case where approach of any external object to the vehicle 5 has been detected (“Yes” in STEP S304), the mobile terminal 1 receives an in-vehicle perspective image from the image processing device 2, and displays the in-vehicle perspective image on the display unit 11 (STEP S305). FIG. 14 is an explanatory view illustrating a situation where an external object is approaching the vehicle 5 according to the second example. In the present example, for example, it is assumed that approach of a person Tr1 from the front right side to the vehicle 5 has been detected.

In the case where approach of the person Tr1 to the vehicle 5 has been detected, the image generating unit 21 generates an in-vehicle perspective image APx including a transparent image 5t as an image of the vehicle 5, on the basis of a virtual viewpoint VPx defined by a viewpoint position which is a predetermined position inside the vehicle 5 and is close to the viewpoint of the driver and a sight line direction which is the direction of the position of the person Tr1 approaching the vehicle 5 as seen from the viewpoint position. FIG. 15 is a schematic diagram illustrating the in-vehicle perspective image APx of the second example. In the in-vehicle perspective image APx, besides the transparent image 5t of the vehicle 5, an image Tp1 of the person Tr1 approaching the vehicle 5 is included.

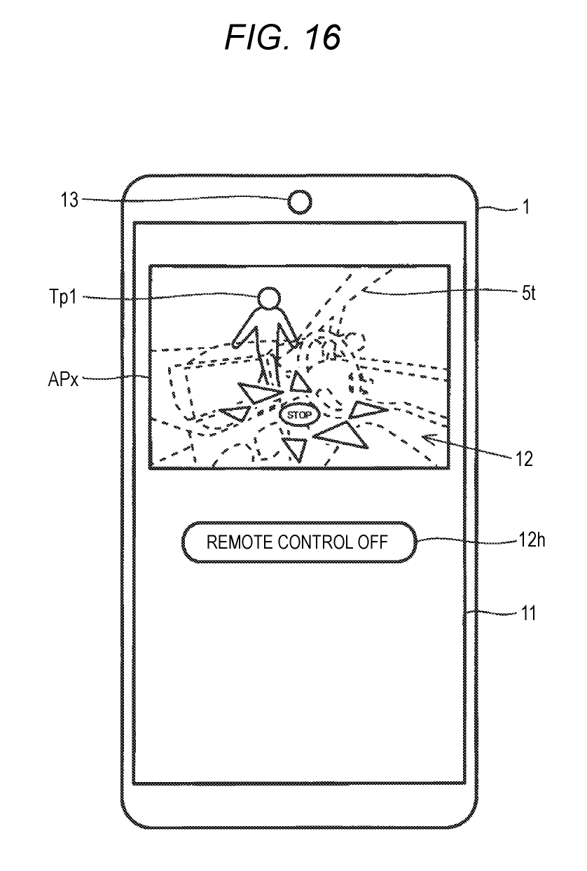

The mobile terminal 1 receives the in-vehicle perspective image APx from the image processing device 2, and displays the in-vehicle perspective image APx on the display unit 11. FIG. 16 is a schematic diagram illustrating the mobile terminal 1 displaying the in-vehicle perspective image APx of the second example. Subsequently, the mobile terminal 1 displays the icons and so on (the operation unit 12) which are function images related to the control on the vehicle 5, on the display unit 11, so as to overlap the in-vehicle perspective image APx (STEP S306). For example, the icons related to traveling of the vehicle 5 are disposed at positions corresponding to the individual traveling directions, so as to overlap the transparent image 5t of the vehicle 5.

In the case where approach of any external object to the vehicle 5 has not been detected (“No” in STEP S304), the mobile terminal 1 receives a bird's eye view image CP1 from the image processing device 2, and displays the bird's eye view image on the display unit 11 (STEP S307). Subsequently, the mobile terminal 1 displays the icons and so on (the operation unit 12) which are function images related to the control on the vehicle 5, on the display unit 11, so as to overlap the bird's eye view image (STEP S308).

Next, the mobile terminal 1 determines whether an operation for turning off remote control on the vehicle 5 has been performed by the user (STEP S309). In the case where an operation for turning off remote control has been performed (“Yes” in STEP S309), the processing flow of the mobile terminal 1 shown in FIG. 13 is ended.

As described above, for example, in the case where approach of the external person Tr1 to the vehicle 5 has been detected, the display unit 11 of the mobile terminal 1 of the present example displays the in-vehicle perspective image APx. According to this configuration, the user may remotely control the vehicle 5 while checking the appearances and behaviors of the person Tr1 and other objects approaching the vehicle 5, on the in-vehicle perspective image APx. Therefore, it is possible to improve safety in remote control. In other words, it is possible to improve convenience in remote control on the vehicle 5.

Further, the display unit 11 displays in-vehicle perspective images APx based on a sight line direction which is the direction of the position of the person Tr1 approaching the vehicle 5. According to this configuration, it is possible to surely check the appearances and behaviors of the person Tr1 and other objects approaching the vehicle 5, on the in-vehicle perspective images APx. Therefore, it is possible to further improve convenience in remote control on the vehicle 5.

### Third Example

### 5-3. Third Example

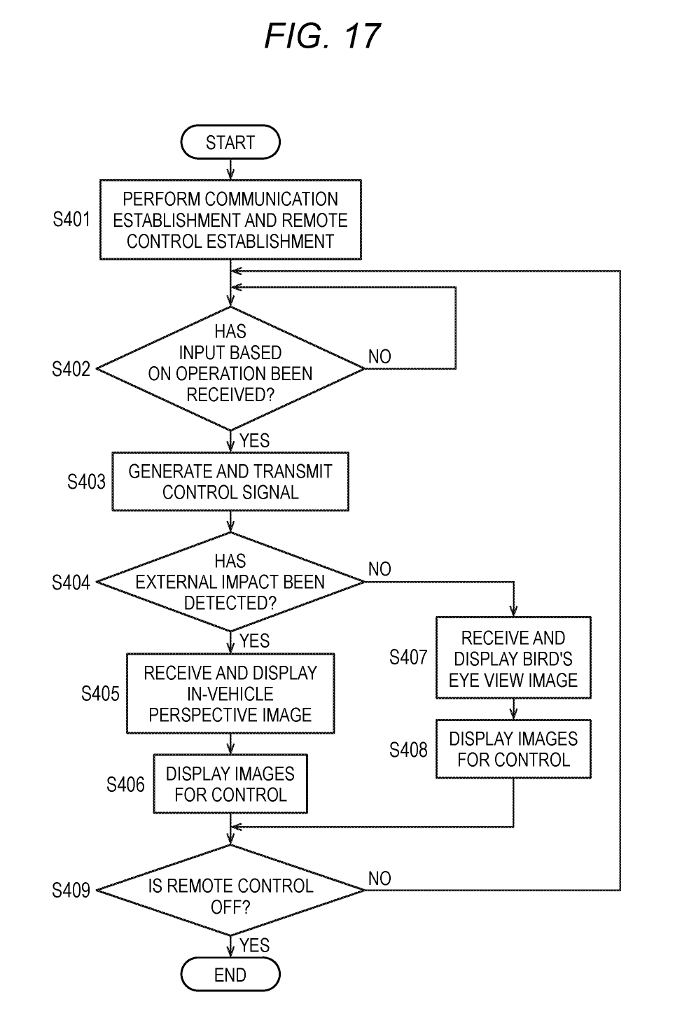

FIG. 17 is a flow chart illustrating an example of the flow of processing of the mobile terminal 1 related to remote vehicle control according to the third example. The processing which is related to remote control on the vehicle 5 and is performed by the mobile terminal 1 according to the third example will be described with reference to FIG. 17. However, since the flow of processing of the vehicle 5 is identical to FIG. 10 described in the first example, a description thereof will not be made. Also, since the flow of processing of the mobile terminal 1 shown in FIG. 17 is identical to FIG. 9 described in the first example, a description thereof will not be made.

For example, if the mobile terminal 1 is operated by the user, and receives a remote control start instruction from the operation unit 12, the processing of the mobile terminal 1 related to remote control on the vehicle 5 is started (“START” of FIG. 17). Remote control on the vehicle 5 is started when the vehicle 5 is stopped.

Next, the mobile terminal 1 performs a communication establishment process and a remote control establishment process in cooperation with the vehicle 5 (STEP S401). Subsequently, the mobile terminal 1 determines whether an input based on an operation on the operation unit 12 has been received (STEP S402). In the case where an input based on a user's operation on the operation unit 12 has been received (“Yes” in STEP S402), the mobile terminal 1 generates a control signal on the basis of the operation on the operation unit 12 by the signal generating unit 163, and transmits the control signal to the vehicle 5 (STEP S403).

Next, whether any external impact on the vehicle 5 has been detected is determined (STEP S404). For example, an impact on the vehicle 5 may be determined on the basis of a detection signal representing the degree of vibration of the vehicle 5 acquired from the vibration sensor of the sensor unit 51. Also, an impact on the vehicle 5 may be determined on the basis of a detection signal representing the degree of tilt of the vehicle 5 acquired from the tilt sensor of the sensor unit 51. Also, with respect to impacts on the vehicle 5, in order to detect the positions and directions of contact of external objects with the vehicle 5, for example, the ultrasonic sensors, the light sensors, the radars, and so on of the sensor unit 51 may be used.

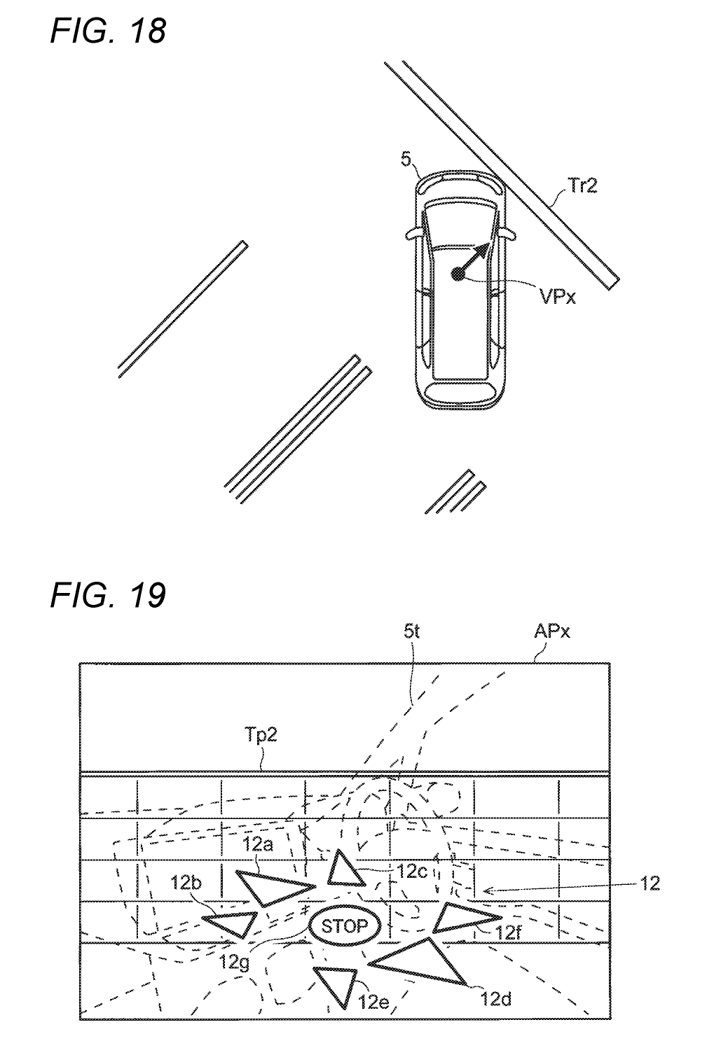

In the case where an external impact on the vehicle 5 has been detected (“Yes” in STEP S404), the mobile terminal 1 receives an in-vehicle perspective image from the image processing device 2, and displays the in-vehicle perspective image on the display unit 11 (STEP S405). FIG. 18 is an explanatory view illustrating a situation where an external object comes into contact with the vehicle 5 of the third example. In the present example, for example, it is assumed that a wall Tr2 has come into contact with the front right part of the vehicle 5, and the external impact has been detected.

In the case where the external impact on the vehicle 5 has been detected, the image generating unit 21 generates an in-vehicle perspective image APx including a transparent image 5t as an image of the vehicle 5, on the basis of a virtual viewpoint VPx defined by a viewpoint position which is a predetermined position inside the vehicle 5 and is close to the viewpoint of the driver and a sight line direction which is the direction of the position of the contact of the wall Tr2 with the vehicle 5 as seen from the viewpoint position. FIG. 19 is a schematic diagram illustrating the in-vehicle perspective image APx of the third example. In the in-vehicle perspective image APx, besides the transparent image 5t of the vehicle 5, an image Tp2 of the wall Tr2 being in contact with the vehicle 5 is included.

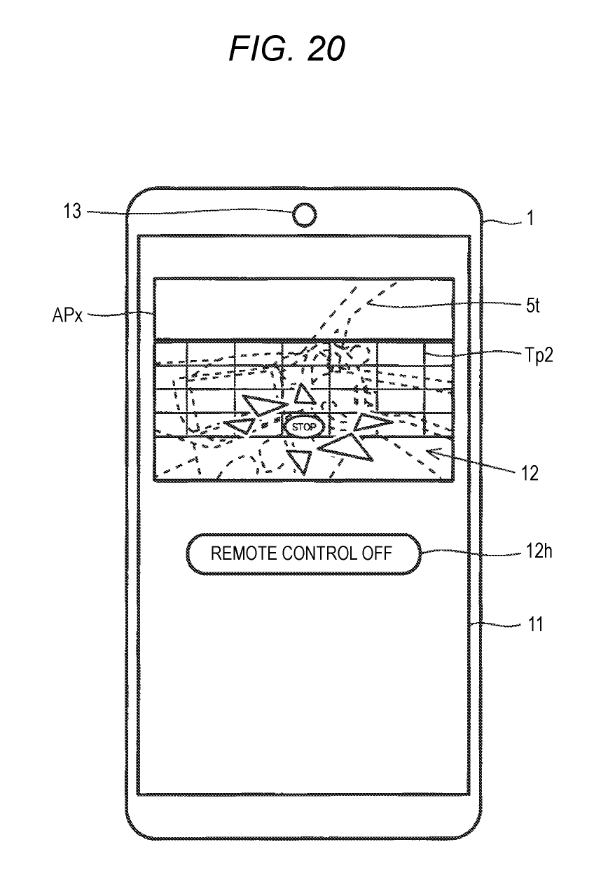

The mobile terminal 1 receives the in-vehicle perspective image APx from the image processing device 2, and displays the in-vehicle perspective image APx on the display unit 11. FIG. 20 is a schematic diagram illustrating the mobile terminal 1 displaying the in-vehicle perspective image APx of the third example. Subsequently, the mobile terminal 1 displays the icons and so on (the operation unit 12) which are function images related to the control on the vehicle 5, on the display unit 11, so as to overlap the in-vehicle perspective image APx (STEP S406). For example, the icons related to traveling of the vehicle 5 are disposed at positions corresponding to the individual traveling directions, so as to overlap the transparent image 5t of the vehicle 5.

In the case where any impact on the vehicle 5 has not been detected (“No” in STEP S404), the mobile terminal 1 receives a bird's eye view image CP1 from the image processing device 2, and displays the bird's eye view image on the display unit 11 (STEP S407). Subsequently, the mobile terminal 1 displays the icons and so on (the operation unit 12) which are function images related to the control on the vehicle 5, on the display unit 11, so as to overlap the bird's eye view image (STEP S408).

Next, the mobile terminal 1 determines whether an operation for turning off remote control on the vehicle 5 has been performed by the user (STEP S409). In the case where an operation for turning off remote control has been performed (“Yes” in STEP S409), the processing flow of the mobile terminal 1 shown in FIG. 17 is ended.

As described above, for example, in the case where an external impact on the vehicle 5 has been detected, the display unit 11 of the mobile terminal 1 of the present example displays in-vehicle perspective images APx. According to this configuration, the user may remotely control the vehicle 5 while checking the appearances and behaviors of the wall Tr2 and other objects being in contact with the vehicle 5, on the in-vehicle perspective images APx. Therefore, it is possible to improve convenience in remote control on the vehicle 5.

Further, in the case where the position of an impact on the vehicle 5 has been specified, the display unit 11 displays in-vehicle perspective images APx based on a sight line direction which is the direction to the position of the impact. According to this configuration, it is possible to surely check the appearances and behaviors of the wall Tr2 and other objects being in contact with the vehicle 5, on the in-vehicle perspective image APx. Therefore, it is possible to further improve convenience in remote control on the vehicle 5.

### Fourth Example

### 5-4. Fourth Example

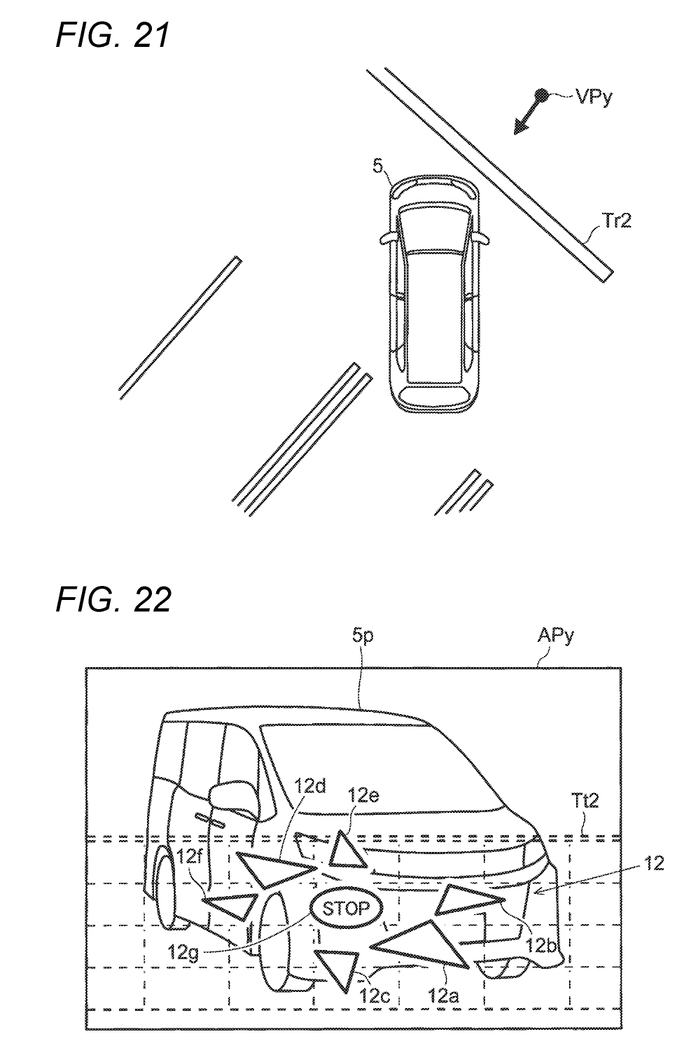

FIG. 21 is an explanatory view illustrating a situation where there is a wall in the vicinity of the vehicle 5 of a fourth example. In the fourth example, for example, it is assumed that a wall Tr2 on the front right side of the vehicle 5 has been detected. Also, objects around the vehicle 5, such as the wall Tr2, are detected, for example, on the basis of detection signals of the ultrasonic sensors, the light sensors, and radars included in the sensor unit 51, or image recognition using images of the on-board cameras 41 to 44.

For example, in the case where the wall Tr2 on the front right side has been detected, the image generating unit 21 generates an auxiliary image APy including an image 5p of the vehicle 5, on the basis of a virtual viewpoint VPy defined by a viewpoint position which is a predetermined position on the front right side outside the vehicle 5 and a sight line direction which is the direction of the position of the vehicle 5 as seen from the viewpoint position. FIG. 22 is a schematic diagram illustrating the auxiliary image APy of the fourth example. In the auxiliary image APy, besides the image 5p of the vehicle 5, a transparent image Tt2 which is an image of the wall Tr2 existing on the front right side of the vehicle 5 is included.

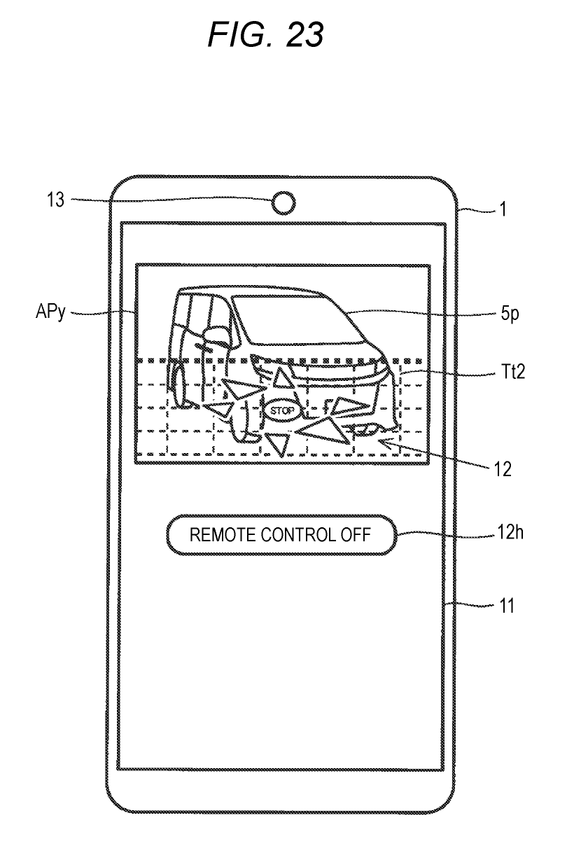

The mobile terminal 1 of the present example receives the auxiliary image APy from the image processing device 2, and displays the auxiliary image APy on the display unit 11. FIG. 23 is a schematic diagram illustrating the mobile terminal 1 displaying the auxiliary image APy according to the fourth example. Further, the mobile terminal 1 displays the icons and so on (the operation unit 12) which are function images related to the control on the vehicle 5, on the display unit 11, so as to overlap the auxiliary image APy. For example, the icons related to traveling of the vehicle 5 are disposed at positions corresponding to the individual traveling directions, so as to overlap the image 5p of the vehicle 5.

As described above, in the case where the wall Tr2 has been detected in the vicinity of the vehicle 5, the display unit 11 of the mobile terminal 1 of the present example displays auxiliary images APy including transparent images Tt2 as images of the wall Tr2. According to this configuration, the blind area attributable to the wall Tr2 is resolved, and it is possible to improve the visibility of the surrounding area of the vehicle 5. Therefore, it is possible to improve operability in remote control on the vehicle 5. Further, it is possible to improve safety during remote control.

### Fifth Example

### 5-5. Fifth Example

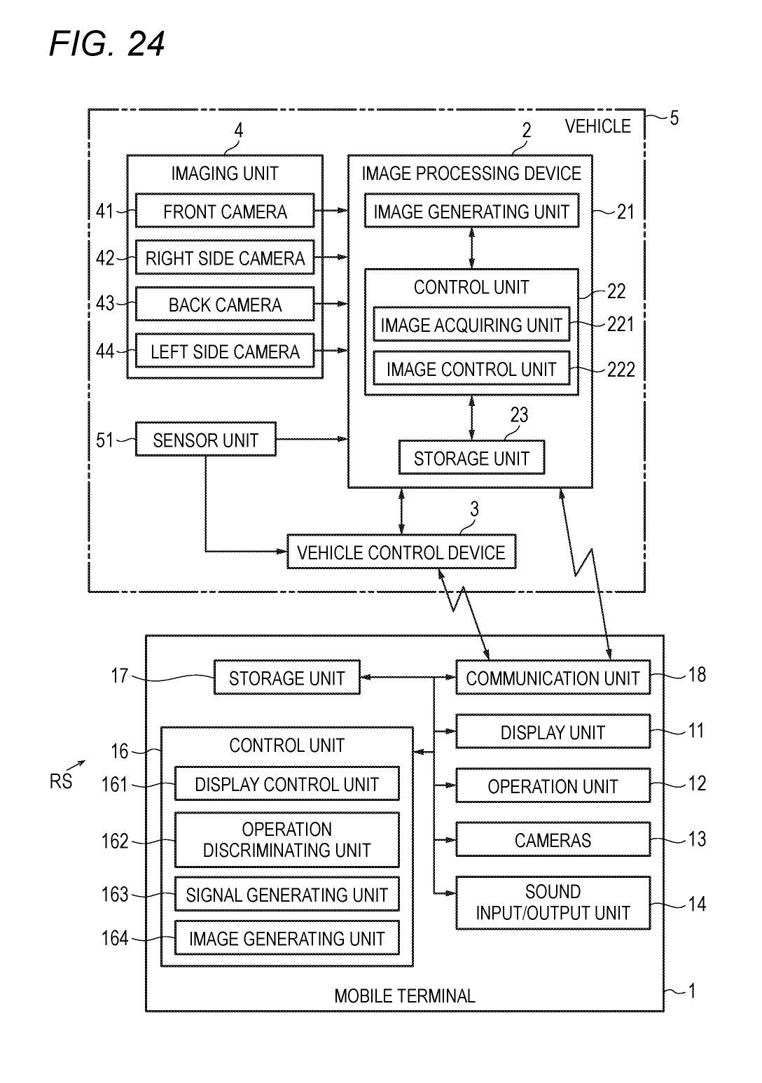

FIG. 24 is a block diagram illustrating the configuration of a remote vehicle control system RS of a fifth example. The mobile terminal 1 of the fifth example has an image generating unit 164, for example, in the control unit 16. The image generating unit 164 generates synthetic images showing the surrounding area of the vehicle 5 by processing images acquired by the imaging unit 4 of the vehicle 5. In the present example, the image generating unit 164 implements a variety of image processing in a software wise, for example, according to a program stored in the storage unit 17.

The mobile terminal 1 receives a variety of data necessary for image processing of the image generating unit 164, from the vehicle 5 via the communication unit 18. As the data necessary for image processing, for example, images acquired by the on-board cameras 41 to 44, the installation states (the installation positions and the camera angles) of the on-board cameras 41 to 44, the camera characteristics (the image size and the image scale), data on images 5p and transparent images 5t of the vehicle 5, and so on are included. The data received from the vehicle 5 is stored, for example, in the storage unit 17.

The image generating unit 164 generates synthetic images showing the surrounding area of the vehicle 5 as seen from virtual viewpoints, on the basis of images acquired by the on-board cameras 41 to 44 and received from the vehicle 5. Further, the image generating unit 164 generates images for display to be displayed on the display unit 11, on the basis of the synthetic images. The image generating unit 164 may generate bird's eye view images and in-vehicle perspective images as synthetic images.

When the user performs remote control on the vehicle 5 using the mobile terminal 1, the mobile terminal 1 performs the communication establishment process and the remote control establishment process in cooperation with the vehicle 5, and then receives a variety of data necessary for image processing of the image generating unit 164 from the vehicle 5. Such data is stored, for example, in the storage unit 17. Thereafter, on the basis of inputs based on user's operations on the operation unit 12, the image generating unit 164 sequentially receives images acquired by the on-board cameras 41 to 44, and generates synthetic images.

### 6. OTHERS

Various technical features disclosed in this specification may be modified variously without departing from the spirit of the technical invention besides the embodiment described above. In other words, it should be understood that the embodiments described above are illustrative and non-restrictive in every respect. It should be understood that the scope of the present invention is defined by the terms of the claims, rather than the description above, and is intended to include any modifications within the scope and meaning equivalent to the terms of the claims. Also, some of the embodiment, the examples, and the modifications described above may be appropriately combined in an acceptable range.

Also, in the above-described embodiment, various functions are implemented in a software wise by computing of the CPUs according to the programs; however, at least some of those functions may be implemented by electrical hardware circuits. Also, conversely, some of functions which are implemented by hardware circuits may be implemented in a software wise.

What is claimed is:

1. A remote vehicle control device comprising:
a display unit;
an operation unit configured for operating a vehicle;
a signal generating unit configured to generate control signals for the vehicle on the basis of operations on the operation unit; and
a communication unit configured to perform communication with the vehicle,
wherein in-vehicle perspective images which are based on viewpoint positions which are predetermined positions inside the vehicle and sight line directions which are the directions to the outside of the vehicle as seen from the viewpoint positions and include transparent images as images of the vehicle are generated on the basis of a plurality of images acquired by a plurality of individual on-board cameras mounted on the vehicle, the display unit displays the in-vehicle perspective images, and
the communication unit transmits the control signals to the vehicle.

2. The remote vehicle control device according to claim 1, wherein:
the communication unit receives the in-vehicle perspective images generated in the vehicle, from the vehicle.

3. The remote vehicle control device according to claim 1, wherein:
the control signals include signals related to control on the viewpoint positions and the sight line directions of the in-vehicle perspective images.

4. The remote vehicle control device according to claim 1, wherein:
when approach of another object to the vehicle is detected, the display unit displays in-vehicle perspective images.

5. The remote vehicle control device according to claim 4, wherein:
the display unit displays in-vehicle perspective images based on a sight line direction which is the direction to the position of the object approaching the vehicle.

6. The remote vehicle control device according to claim 1, wherein:
when an impact on the vehicle is detected, the display unit displays in-vehicle perspective images.

7. The remote vehicle control device according to claim 6, wherein:
in a case where the position of the impact is specified in the vehicle, the display unit displays in-vehicle perspective images based on a sight line direction which is the direction to the position of the impact.

8. The remote vehicle control device according to claim 1, wherein:
when a wall is detected in the vicinity of the vehicle, the display unit displays auxiliary images including transparent images as images of the wall.

9. The remote vehicle control device according to claim 1, wherein:
the transparent images of the vehicle in the in-vehicle perspective images are wireframe images configured with sets of lines representing sides of a three-dimensional shape representing the vehicle.

10. The remote vehicle control device according to claim 1, wherein:
the transparent images of the vehicle in the in-vehicle perspective images are semi-transparent images of a three-dimensional shape representing the vehicle.

11. A remote vehicle control method comprising:
generating in-vehicle perspective images which are based on viewpoint positions which are predetermined positions inside a vehicle and a sight line direction which is the directions of the vehicle as seen from the viewpoint positions and include transparent images as images of the vehicle, on the basis of a plurality of images acquired by a plurality of individual on-board cameras mounted on the vehicle
displaying the in-vehicle perspective images on a remote vehicle control device;
receiving operations for the vehicle by the remote vehicle control device;
generating control signals for the vehicle based on the operations; and
transmitting the control signals from the remote vehicle control device to the vehicle.
